(19) United States
(12) Patent Application Publication
(10) Pub. No.: US 2013/0106239 A1
(43) Pub. Date: May 2, 2013

(54) VIBRATION DEVICE AND HAPTIC FEEDBACK DEVICE INCLUDING THE SAME

(71) Applicant: SAMSUNG ELECTRO-MECHANICS CO., LTD., Suwon (KR)

(72) Inventors: Dae Woong YUN, Suwon (KR); Jae Kyung KIM, Suwon (KR); Dong Sun PARK, Suwon (KR); Yeon Ho SON, Suwon (KR)

(73) Assignee: SAMSUNG ELECTRO-MECHANICS CO., LTD., Suwon (KR)

(21) Appl. No.: 13/650,909

(22) Filed: Oct. 12, 2012

(30) Foreign Application Priority Data
Oct. 28, 2011 (KR) 10-2011-0111272

(51) Int. Cl. H02N 2/04

(52) U.S. Cl. 310/300

(57) ABSTRACT

There is provided a vibration device and a haptic feedback device including the same. The vibration device includes: a first plate member; a vibration member attached to the first plate member to vibrate the first plate member; and a second plate member connected to the first plate member, wherein the first plate member includes a fixing unit used to fix a position of the vibration member or limit the position of the vibration member to be within a predetermined range.

### CROSS-REFERENCE TO RELATED APPLICATIONS

This application claims the priority of Korean Patent Application No. 10-2011-0111272 filed on Oct. 28, 2011, in the Korean Intellectual Property Office, the disclosure of which is incorporated herein by reference.

### BACKGROUND OF THE INVENTION

1. Field of the Invention

The present invention relates to a vibration device and a haptic feedback device including the same, and more particularly, to a vibration device in which a vibration member may be easily fixed or attached, and a haptic feedback device including the same.

2. Description of the Related Art

To increase user convenience, a touch type input/output device on which selection buttons are displayed (a so-called haptic feedback device) is generally used. A haptic feedback device refers to a device using a method in which a user directly inputs a signal, for example, with a finger tip, which provides a high degree of user convenience that the user may provide input signals while simultaneously visually confirming information output from the device.

The haptic feedback device allows for a reduction in space, provides increased operability and convenience, and feedback therefrom is easily experienced by a user. In addition, the haptic feedback device may be easily connected to information technology (IT) devices. Consequently, the haptic feedback device is widely used as an input/output device in a guide apparatus for providing information to a user in certain public places such as subway stations, hospitals, schools, etc.

Meanwhile, the haptic feedback device includes a vibration device for informing a user as to whether an input signal has been received or whether an output signal has been output. The vibration device includes a vibration member such as a piezoelectric element and a plate member vibrated by the vibration member.

However, recently, as the size of the vibration device has gradually been reduced, it is difficult to attach or fix the vibration member to a considerably narrow surface of the plate member. In particular, the plate member, on which the vibration member is not properly mounted, is not able to generate vibrations within a designed frequency range, and thus, the development of the vibration device in which the vibration member is capable of being accurately attached or fixed to the plate member is required.

### SUMMARY OF THE INVENTION

An aspect of the present invention provides a vibration device capable of accurately locating a vibration member, and a haptic feedback device including the same.

According to an aspect of the present invention, there is provided a vibration device comprising: a first plate member; a vibration member attached to the first plate member to vibrate the first plate member; and a second plate member connected to the first plate member, wherein the first plate member includes a fixing unit used to fix a position of the vibration member or limit the position of the vibration member to be within a predetermined range.

The fixing unit may be a protrusion protruded from the first plate member.

The fixing unit and the vibration member may form a space receiving an adhesive injected thereinto.

The protrusion may be formed by cutting a portion of the first plate member.

The protrusion may be formed on an end of the vibration member.

The protrusion may be bent toward the vibration member.

The fixing unit may be a groove formed in the first plate member.

The groove may be formed by cutting a portion of the first plate member.

The vibration device may further include a mass body fixed to the second plate member.

According to another aspect of the present invention, there is provided a haptic feedback device including the vibration device as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a vibration device according to an embodiment of the present invention;

FIG. 2 is an assembled perspective view of the vibration device illustrated in FIG. 1;

FIGS. 3 and 4 are side views of a vibration device according to another embodiment of the present invention;

FIG. 5 is an exploded perspective view of a vibration device according to another embodiment of the present invention;

FIG. 6 is an exploded perspective view of a vibration device according to another embodiment of the present invention; and

FIG. 7 is a cross-sectional view of the vibration device of FIG. 6, taken along line A-A.

### DETAILED DESCRIPTION OF THE EMBODIMENTS

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

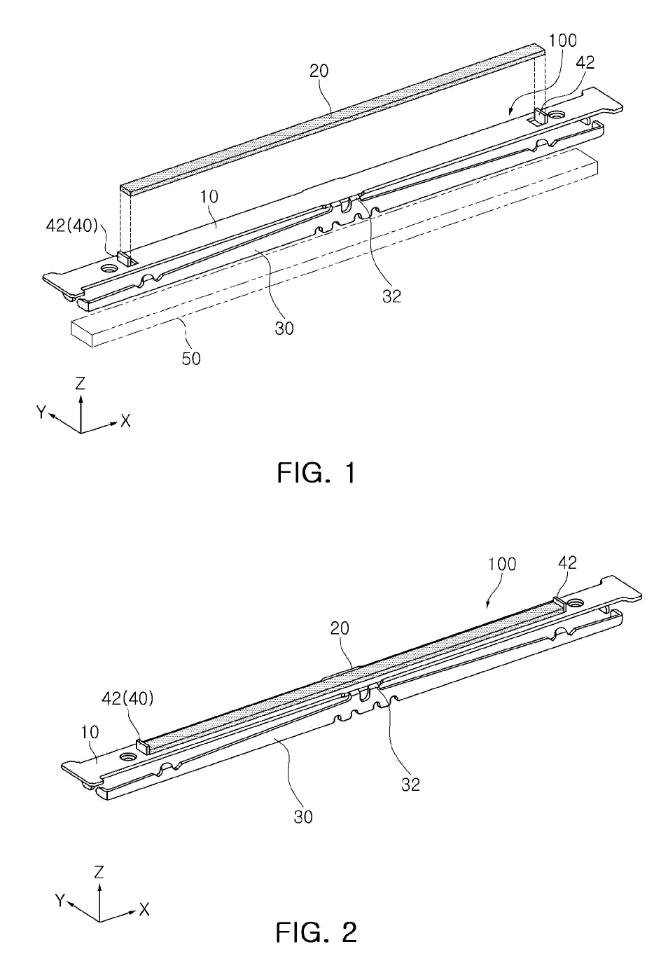

FIG. 1 is an exploded perspective view of a vibration device 100 according to an embodiment of the present invention. FIG. 2 is an assembled perspective view of the vibration device illustrated in FIG. 1.

The vibration device 100 may include a first plate member 10, a vibration member 20, a second plate member 30, and a fixing unit 40. The vibration device 100 may be provided in a mobile phone or another portable electronic device such as a portable electronic dictionary. Also, the vibration device 100 may be connected to an input/output device of a corresponding electronic device and transmit vibrations to a user. However, the vibration device 100 is not limited to the above-described portable electronic devices, and may be installed in, for example, automatic teller machines (ATMs) or subway route guide apparatuses installed in subway stations that include a touch screen.

The first plate member 10 may have a rectangular cross-section, and may be formed of a material having a predetermined level of elasticity. For example, the first plate member 10 may be formed of a material such as a metal or a plastic. Also, a spring constant K of the first plate member 10 may be determined such that the vibration device 100 has a predetermined oscillation frequency within a range of 100 Hz to 300 Hz. The first plate member 10 may be fixed to a portable electronic device. In detail, two ends of the first plate member 10 maybe fixed to a body or a case of a portable electronic device. However, as the first plate member 10 is formed of an elastic material as described above, the first plate member 10 may vibrate in a vertical direction (a Z-axis direction of FIG. 1) when vibrated by the vibration member 20. Meanwhile, although not illustrated in FIG. 1, a coupling hole for coupling with the case may be formed in the first plate member 10.

The vibration member 20 may be fixed to the first plate member 10. In detail, the vibration member 20 may be forcedly fitted to the first plate member 10. Alternatively, to increase coupling force between the vibration member 20 and the first plate member 10, an adhesive may be additionally applied to a bonding surface between the vibration member 20 and the first plate member 10. The adhesive may be an epoxy resin adhesive .

Meanwhile, the vibration member 20 may be a piezoelectric element that may be easily contracted or extended according to an electrical signal. For example, the vibration member 20 may be formed of a lead zirconium titanite (PZT) ceramic. The vibration member 20 formed as described above may be contracted or extended according to an electrical signal to generate vibrations in the first plate member 10.

The second plate member 30 may be connected to the first plate member 10. In detail, the second plate member 30 may be integrally formed with the first plate member 10 via a connection portion 32. In detail, the second plate member 30 may be integrally formed with the first plate member 10 by using press processing. The second plate member 30 may be arranged to be parallel to a vibration direction (that is, the Z-axis direction) of the first plate member 10 as illustrated in FIG. 1. That is, the second plate member 30 may be bent in a direction perpendicular to the first plate member 10.

The second plate member 30 may have a predetermined mass so that the vibration device 100 has a relatively low oscillation frequency. Alternatively, the second plate member 30 may have a form to accommodate a mass body 50 (see FIG. 5) having a predetermined mass. For example, as illustrated in FIG. 1, two ends of the second plate member 30 may be bent in the same direction and may be firmly coupled to the mass body 50.

Meanwhile, according to the conventional art, the first plate member 10 and the vibration member 20 are fixed and coupled, simply using an adhesive. However, as the first plate member 10 and the vibration member 20 have a relatively thin elongated shape to allow the vibration device 100 to be compact, it is difficult to correctly locate or fix the vibration member 20 on or to the first plate member 10. Also, as the first plate member 10 is vertically vibrated at any time by the vibration member 20, coupling force between the first plate member 10 and the vibration member 20 may be easily reduced, and moreover, a coupling position of the vibration member 20 is likely to deviate from an initial position.

The present invention is provided to solve the above problems. According to the embodiment of the present invention, the first plate member 10 further includes the fixing unit 40.

The fixing unit 40 may be formed on two end portions of the first plate member 10 as illustrated in FIG. 1, and may be a protrusion 42 protruded from the first plate member 10 in a predetermined direction (+Z direction in FIG. 1). In detail, the protrusion 42, the fixing unit 40, may be formed in a position at which two ends of the vibration member 20 may be held via the first plate member 10. The protrusion 42 formed as described above may contact two ends of the vibration member 20 as illustrated in FIG. 2, thereby correcting a position of the vibration member 20 and increasing coupling force between the first plate member 10 and the vibration member 20.

Meanwhile, the protrusion 42 may be integrally formed with the first plate member 10. For example, the protrusion 42 may be formed by cutting a portion of the first plate member 10 and bending the cut portion in a predetermined direction. This structure may be integrally formed during a press processing operation of the first plate member 10 and the second plate member 20, and thus, the manufacturing costs of the vibration device 100 may be reduced.

According to the present embodiment, the coupling position of the vibration member 20 is corrected by the protrusion 42, the fixing unit 40, and thus the coupling force between the first plate member 10 and the vibration member 20 may be improved.

In addition, according to the present embodiment, the protrusion 42 may be formed by cutting a portion of the first plate member 10, and thus, a spring constant of the first plate member 10 may be easily reduced. Accordingly, according to the present embodiment, an oscillation frequency of the vibration device 100 may easily be reduced merely by forming the protrusion 42.

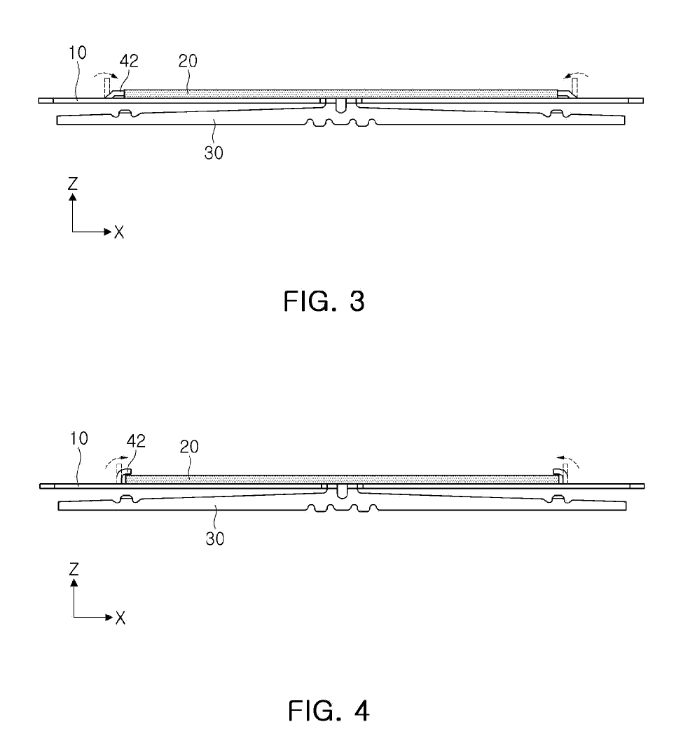

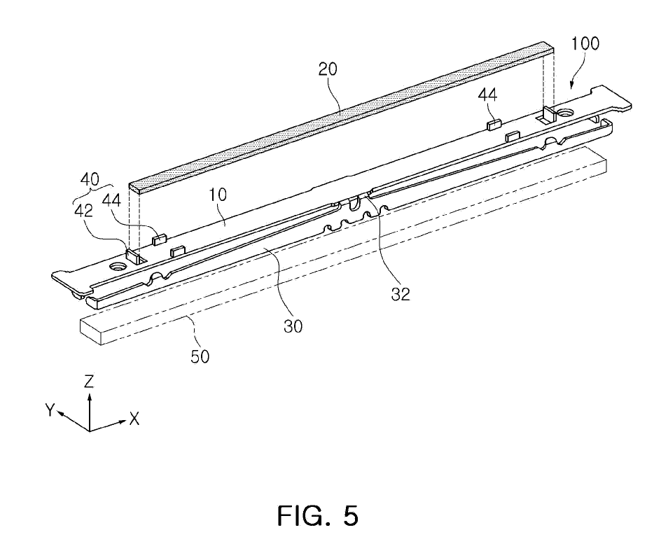

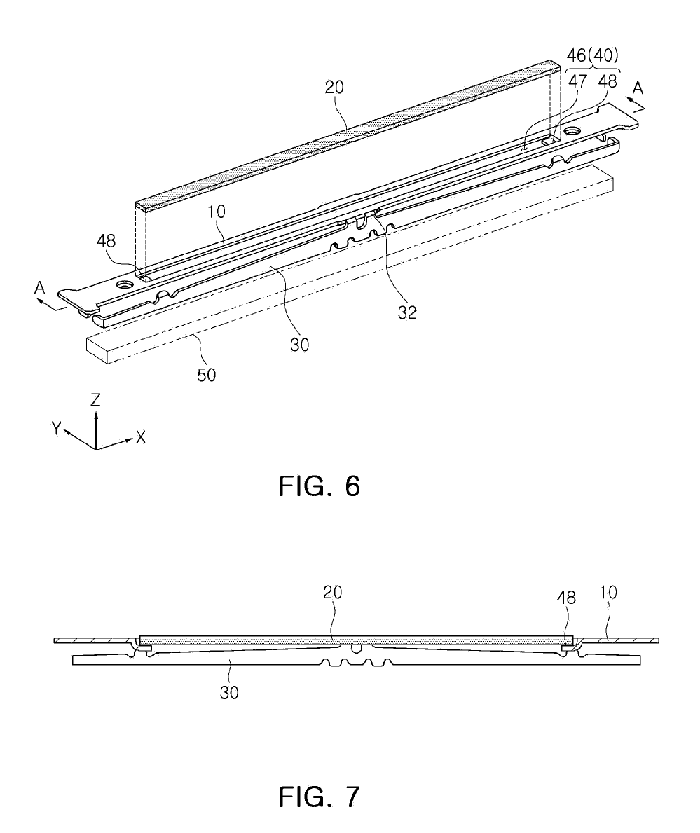

FIGS. 3 and 4 are side views of a vibration device 100 according to another embodiment of the present invention. FIG. 5 is an exploded perspective view of a vibration device according to another embodiment of the present invention. FIG. is an exploded perspective view of a vibration device according to another embodiment of the present invention. FIG. 7 is a cross-sectional view of the vibration device of FIG. 6, taken along line A-A.

For reference, the same reference numerals as in the previous embodiment denote the same elements, and repeated element descriptions will be omitted.

The vibration device 100 according to another embodiment of the present invention will be described with reference to FIGS. 3 and 4.

The vibration device 100 according to the present embodiment may be distinguished from the vibration device 100 according to the previous embodiment in regard to the form of the protrusion 42.

According to the present embodiment, the protrusion 42 may be bent toward the vibration member 20. For example, as illustrated in FIG. 3, the protrusion 42 may be bent toward an end surface of the vibration member 20 (a surface parallel to a Y-Z plane in FIG. 3). Alternatively, as illustrated in FIG. 4, the protrusion 42 may be bent toward an upper surface of the vibration member 20 (the surface parallel to an X-Y plane in FIG. 3).

Here, coupling of the first plate member 10 and the vibration member 20 may be conducted by forcedly inserting the vibration member 20 between the protrusions 42 that are bent, by mounting the vibration member 20 on the first plate member 10 and bending the protrusions 42.

According to the present embodiment, coupling force between the protrusion 42 and the vibration member 20 may be excellent, and thus the structure according to the present embodiment may be effectively used in the vibration device 100 which requires relatively large vibrations.

A vibration device 100 according to another embodiment of the present invention will be described with reference to FIG. 5.

The vibration device 100 according to the present embodiment may be distinguished from those of the previous embodiments, in that the vibration device 100 further includes a lateral protrusion 44. Furthermore, in the vibration device 100 according to the present embodiment, a mass body 50 may be further mounted on the second plate member 30.

The lateral protrusions 44 may be formed at predetermined intervals in a length direction of the first plate member 10 (X-axis direction in FIG. 5). In addition, the lateral protrusion 44 may be integrally formed with the first plate member 10 and by cutting a portion of the first plate member 10.

The mass body 50 may be coupled to the second plate member 30. In detail, the mass body 50 may be forcedly fixed to the second plate member 30 or be attached to the second plate member 30 using an adhesive. The mass body 50 may have a predetermined mass, and may reduce an oscillation frequency of the vibration device 100.

According to the present embodiment, deviation of the vibration member 20 from the first plate member 10 in a horizontal direction (Y-axis direction in FIG. 5) may be effectively prevented by using the lateral protrusion 44.

Also, according to the present embodiment, the mass body 50 is further added to the second plate member 30, and thus, an oscillation frequency of the vibration device 100 may be easily adjusted by increasing or reducing the mass of the mass body 50.

A vibration device 100 according to another embodiment of the present invention will be described with reference to FIGS. 6 and 7.

The vibration device 100 according to the present embodiment may be distinguished from those of the previous embodiments, in that the fixing unit 40 is provided in the form of a groove 46.

According to the present embodiment, the groove 46, the fixing unit 40, may be in a form extending in a length direction of the first plate member 10 (an X-axis direction in FIG. 6). The groove 46 may be formed by a hole 47 passing through the first plate member 10 and a cutting piece 48 that is bent downward from the first plate member 10. The cutting piece 48 may be a portion of the first plate member 10 that is cut in order to form the hole 47.

The vibration member 20 as illustrated in FIG. 7 may be received in the groove 46. Here, a bottom surface of the vibration member 20 may be supported by the cutting piece 48, and the vibration member 20 may be supported at all sides by an inner peripheral surface of the hole 47.

Accordingly, according to the present embodiment, not only the vibration member 20 may be stably mounted on the first plate member 10 but a mounting position of the vibration member 20 may be easily aligned by using the hole 47.

Although not shown in the drawings, the vibration device 100 according to the above embodiments of the present invention may be included in a mobile phone, a portable electronic dictionary, a portable electronic device, or another haptic feedback device provided in an electronic device including a touch screen.

Accordingly, according to the present invention, a haptic feedback device including the above-described vibration device 100 may also be regarded as a form according to an embodiment of the present invention.

According to embodiments of the present invention, a vibration member may be accurately located on a first plate member, and thus vibrations within a designed frequency range may be effectively generated.

Also, as the vibration member is stably located on the first plate member, the vibration member is not detached from the first plate member due to an external impact. Accordingly, a vibration device having excellent durability may be provided.

In addition, according to the embodiments of the present invention, the vibration member is fixed by cutting a portion of the first plate member (that is, a spring constant of the first plate member is relatively reduced), and thus vibrations within a low frequency range may easily be generated.

While the present invention has been shown and described in connection with the exemplary embodiments, it will be apparent to those skilled in the art that modifications and variations can be made without departing from the spirit and scope of the invention as defined by the appended claims.

What is claimed is:

1. A vibration device comprising:
a first plate member;
a vibration member attached to the first plate member to vibrate the first plate member; and
a second plate member connected to the first plate member,
wherein the first plate member includes a fixing unit used to fix a position of the vibration member or limit the position of the vibration member to be within a predetermined range.

2. The vibration device of claim 1, wherein the fixing unit is a protrusion protruded from the first plate member.

3. The vibration device of claim 1, wherein the fixing unit and the vibration member form a space receiving an adhesive injected thereinto.

4. The vibration device of claim 2, wherein the protrusion is formed by cutting a portion of the first plate member.

5. The vibration device of claim 2, wherein the protrusion is formed on an end of the vibration member.

6. The vibration device of claim 2, wherein the protrusion is bent toward the vibration member.

7. The vibration device of claim 1, wherein the fixing unit is a groove formed in the first plate member.

8. The vibration device of claim 7, wherein the groove is formed by cutting a portion of the first plate member.

9. The vibration device of claim 1, further comprising a mass body fixed to the second plate member.

10. A haptic feedback device comprising a vibration device,
the vibration device including:
a first plate member;
a vibration member attached to the first plate member to vibrate the first plate member; and
a second plate member connected to the first plate member,
the first plate member having a fixing unit fixing a position of the vibration member or limit the position of the vibration member within a predetermined range.

11. The haptic feedback device of claim 10, wherein the fixing unit is a protrusion protruded from the first plate member.

12. The haptic feedback device of claim 10, wherein the fixing unit and the vibration member form a space receiving an adhesive injected thereinto.

13. The haptic feedback device of claim 11, wherein the protrusion is formed by cutting a portion of the first plate member.

14. The haptic feedback device of claim 11, wherein the protrusion is formed on an end of the vibration member.

15. The haptic feedback device of claim 11, wherein the protrusion is bent toward the vibration member.

16. The haptic feedback device of claim 10, wherein the fixing unit is a groove formed in the first plate member.

17. The haptic feedback device of claim 16, wherein the groove is formed by cutting a portion of the first plate member .

18. The haptic feedback device of claim 10, further comprising a mass body fixed to the second plate member.
